(19) United States
(12) Patent Application Publication
(10) Pub. No.: US 2023/0271746 A1
(43) Pub. Date: Aug. 31, 2023

(54) PARTITION STRUCTURE AND PACKAGING BOX USING THE SAME

(71) Applicants: Futaijing Precision Electronics (Yantai) Co., Ltd., Yantai (CN); HON HAI PRECISION INDUSTRY CO., LTD., New Taipei (TW)

(72) Inventor: SZU-NI CHEN, New Taipei (TW)

(21) Appl. No.: 17/714,447

(22) Filed: Apr. 6, 2022

(30) Foreign Application Priority Data
Feb. 25, 2022 (CN) 202220393309.1

(51) Int. Cl. B65D 5/49

(52) U.S. Cl. CPC B65D 5/48024

(57) ABSTRACT

A partition structure for product packaging box includes a bottom plate, an inner lining plate, a first side plate, and a second side plate. The bottom plate defines a first through hole. The inner lining plate is arranged at intervals with the bottom plate along the first direction and a second through hole communicating with the first through hole is defined along a first direction. The first side plate includes a tongue passing through first and second through holes along the first direction. The second side plate is connected with the bottom plate. The second side plate and the first side plate are arranged at intervals along a second direction, the second side plate being on the same side of the bottom plate and the inner lining plate. The bottom plate, the inner lining plate, the first side plate, and the second side plate are integrally connected.

### FIELD

The subject matter herein generally relates to product packaging, in particular relates to a packing case including a partition structure.

### BACKGROUND

In order to avoid damaging electronic devices during transportation, the electronic devices need to be protected with partition structures as buffers. However, traditional partition structures are made of foam materials, which has huge material volume, high preparation cost, and is toxic to the environment.

Many areas have banned or restricted the use of foamed materials and advocated using cardboard to make the partition structure. However, most partition structures are made of several pieces of cardboard interlocked with each other. The size of partition structure is not easy to adjust, the assembling procedure is cumbersome, and re-cyclability is low.

### BRIEF DESCRIPTION OF THE DRAWINGS

Implementations of the present technology will now be described, by way of embodiments with reference to the attached figures.

FIG. 1 is a schematic perspective diagram of a partition structure of a packaging box according to a first embodiment of the present disclosure.

FIG. 2 is a schematic perspective diagram of a partition structure according to a second embodiment of the present disclosure.

FIG. 3 is a schematic perspective diagram of a partition structure according to a third embodiment of the present disclosure.

FIG. 4 is a diagram of the partition structure in an unfolded state according to an embodiment of the present disclosure.

FIG. 5 is a schematic perspective diagram of a packaging box having the partition structure in FIG. 2.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale, and the proportions of certain parts may be exaggerated to better show details and features of the present disclosure. The disclosure is by way of embodiments and not by way of limitation in the figures of the accompanying drawings, in which like references indicate similar elements. It should be noted that references to “an” or “one” embodiment in this disclosure are not necessarily to the same embodiment, and such references mean “at least one.”

Several definitions that apply throughout this disclosure will now be presented.

The term “substantially” is defined to be essentially conforming to the particular dimension, shape, or other feature that the term modifies, such that the component need not be exact. For example, “substantially cylindrical” means that the object resembles a cylinder, but can have one or more deviations from a true cylinder. The term “comprising,” when utilized, means “including, but not necessarily limited to”; it specifically indicates open-ended inclusion or membership in the so-described combination, group, series, and the like. References to “a plurality of” and “a number of” mean “at least two”.

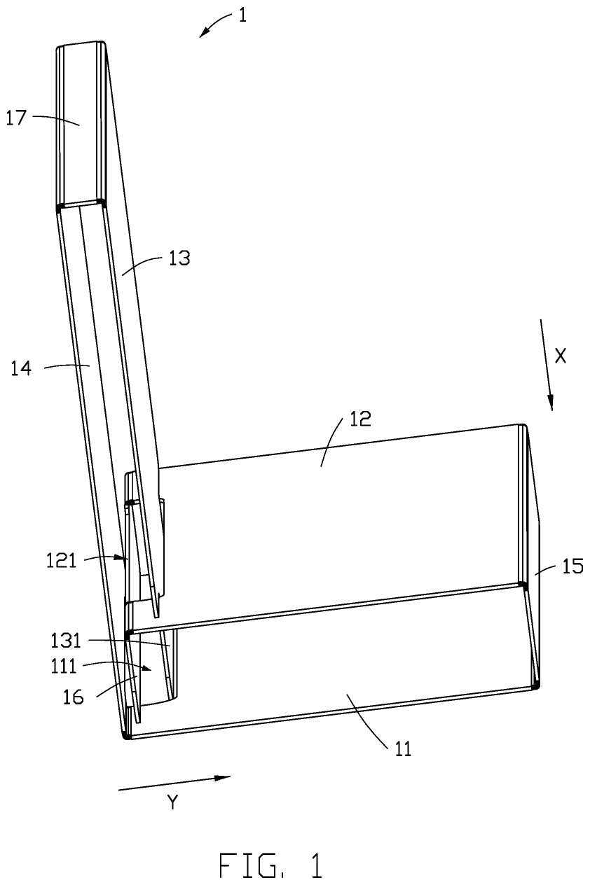

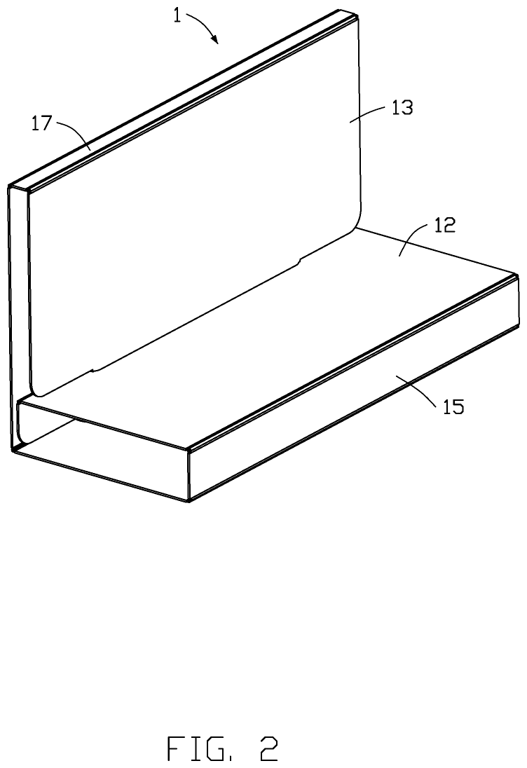

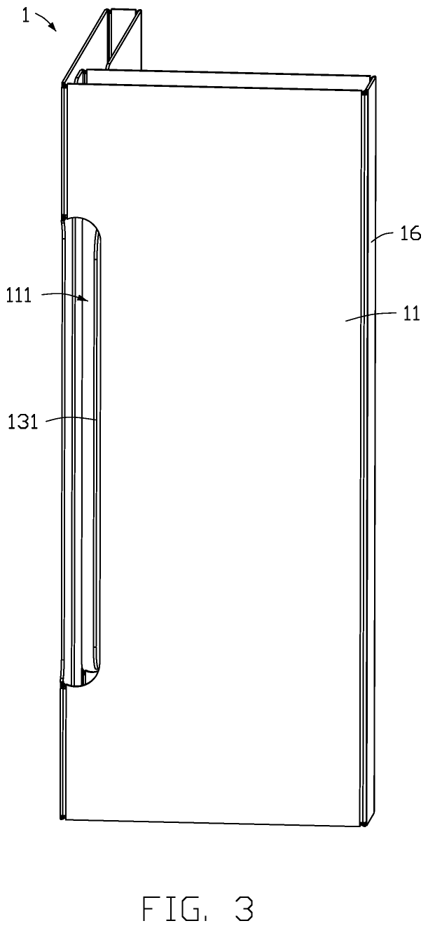

Referring to FIGS. 1-3, a partition structure 1 is provided. The partition structure 1 includes a bottom plate 11, an inner lining plate 12, a first side plate 13, and a second side plate 14. The bottom plate 11 defines a first through hole 111. The inner lining plate 12 is spaced from the bottom plate 11 along the first direction X. The inner lining plate 12 defines a second through hole 121 and the first through hole 111 communicating with the second through hole 121 along the first direction X. The first side plate 13 is arranged along the first direction X, the first side plate 13 includes a tongue 131, and the tongue 131 successively passes through the first through hole 111 and the second through hole 121 along the first direction X. The second side plate 14 is connected with the bottom plate 11, the second side plate 14 and the first side plate 13 are arranged at intervals along the second direction Y, and the second side plate 14 is arranged on the same side as the bottom plate 11 and the lining plate 12, along the first direction X.

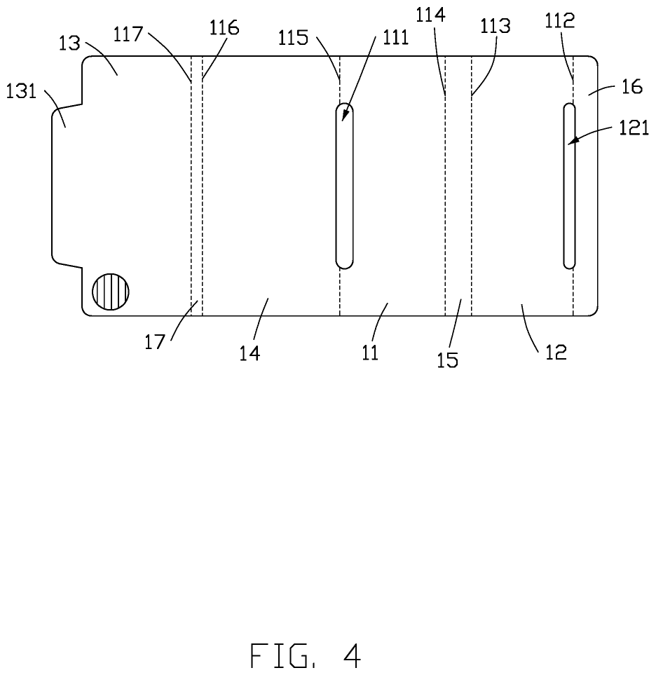

In an embodiment, the bottom plate 11, the inner lining plate 12, the first side plate 13, and the second side plate 14 are an integrated paperboard structure. The integrated paperboard structure is folded according to preset crease line as shown in FIG. 4 to form an “L” shaped partition structure 1. This allows full use to be made of the foldability of the paper structure to render the bottom plate 11, the inner lining plate 12, the first side plate 13, and the second side plate 14 into an interlockable structure providing the function of isolation and creating a lining. The partition structure 1 has the advantages of simple operation, is very practical, and has low production cost. At the same time, the partition structure 1 meets environmental concerns.

In this embodiment, the bottom plate 11 is a rectangular structure with a length of 138 mm and a width of 56 mm, the inner liner 12 is a rectangular structure with a length of 138 mm and a width of 54 mm, and the first side plate 13 is a rectangular structure with a length of 138 mm and a width of 58 mm. The tongue 131 is a rectangular structure with a length of 87 mm and a width of 16 mm, the second side plate 14 is a rectangular structure with a length of 138 mm and a width of 73 mm, and the first through hole 111 is an elliptical structure with a height of 88 mm and a radius of 4.5 mm. The second through hole 121 is an elliptical structure with a height of 88 mm and a radius of 3 mm. In this embodiment, a size of the partition structure 1 is adjustable according to need, the partition structure 1 has wide range of applications.

In another embodiment, the bottom plate 11, the inner lining plate 12, the first side plate 13, and the second side plate 14 are structures which can be separated. The shapes and sizes of the bottom plate 11, the lining plate 12, the first side plate 13, and the second side plate 14 can be adjusted according to actual needs, and the sizes of the first through hole 111, the second through hole 121 and the tongue 131 can also be adjusted according to the actual needs. As a condition, the width of the bottom plate 11 is greater than the width of the inner lining plate 12, and the length of the first through hole 111 and the second through hole 121 is greater than the length of the tongue 131. The sum of the width of the tongue 131 and the first side plate 13 is greater than the width of the second side plate 14 and less than the sum of the width of the second side plate 14 and the thickness of the bottom plate 11, so as to achieve the diaphragm structure 1.

In an embodiment, the partition structure 1 further includes a third side plate 15. The third side plate 15 is arranged between the bottom plate 11 and the inner lining plate 12, and the bottom plate 11 and the inner lining plate 12 are connected through the third side plate 15. Opposite ends of the third side plate 15 are connected with the bottom plate 11 and the inner lining plate 12. The third side plate 15 is arranged on the side of the bottom plate 11 away from the first through hole 111, and the third side plate 15 is arranged on the side of the lining plate 12 away from the second through hole 121. The third side plate 15 is spaced from the second side plate 14 along the second direction Y.

In an embodiment, the partition structure 1 further includes the fourth side plate 16. The fourth side plate 16 is connected with the lining plate 12, and the third side plate 15 and the fourth side plate 16 are arranged on each side opposite to the inner lining plate 12. The fourth side plate 16 extends along the first direction X towards the first through hole 111 and abuts the bottom plate 11. The side of the fourth side plate 16 away from the bottom plate 11 is connected with the side of the inner lining plate 12 adjacent to the second through hole 121, and the fourth side plate 16 is arranged between the first side plate 13 and the second side plate 14.

In an embodiment, the partition structure 1 further includes a fifth side plate 17. The fifth side plate 17 is arranged between the first side plate 13 and the second side plate 14, the fifth side plate 17 is arranged at intervals with the bottom plate 11 along the first direction X. The first side plate 13 and the second side plate 14 are connected by the fifth side plate 17, and one side of the fifth side plate 17 is connected with a side of the first side plate 13 away from the tongue 131. The other side of the fifth side plate 17 is connected with a side of the second side plate 14 away from the bottom plate 11.

In an embodiment, along the first direction X, the orthographic projection of the inner lining plate 12 covers the orthographic projection of the bottom plate 11, and the orthographic projection of the fifth side plate 17 covers the first through hole 111 and the second through hole 121. Along the second direction Y, the orthographic projection of the second side plate 14 covers the orthographic projection of the first side plate 13, and the orthographic projection of the third side plate 15 covers the orthographic projection of the tongue 131 and the fourth side plate 16.

In an embodiment, the third side plate 15 is a rectangular structure with a length of 138 mm and a width of 16 mm. The fourth side plate 16 is a rectangular structure with a length of 138 mm and a width of 13 mm. The fifth side plate 17 is a rectangular structure with a length of 138 mm and a width of 6 mm.

In another embodiment, the shapes and sizes of the third side plate 15, the fourth side plate 16, and the fifth side plate 17 can be adjusted according to the actual need, as long as the partition structure 1 can be realized.

In an embodiment, the thickness of the fourth side plate 16, the inner lining plate 12, the third side plate 15, the bottom plate 11, the second side plate 14, the fifth side plate 17, and the first side plate 13 are greater than or equal to 1 mm, so that the foldability of the paper structure allows an interlocked structure to be formed.

Referring to FIG. 4, the fourth side plate 16, the inner lining plate 12, the third side plate 15, the bottom plate 11, the second side plate 14, the fifth side plate 17, and the first side plate 13 are connected in sequence and arranged as a single structure.

In this embodiment, the fourth side plate 16 and the inner plate 12 are divided by the first crease line 112, the inner plate 12 and the third side plate 15 are divided by the second crease line 113, and the third side plate 15 and the bottom plate 11 are divided by the third crease line 114. The bottom plate 11 and the second side plate 14 are divided by the fourth crease line 115, and the second side plate 14 and the fifth side plate 17 are divided by the fifth crease line 116. The fifth side plate 17 and the first side plate 13 are divided by the sixth crease line 117.

In this embodiment, the fourth side plate 16, the inner lining plate 12, the third side plate 15, the bottom plate 11, the second side plate 14, the fifth side plate 17, and the first side plate 13 are paper structures. The fourth side plate 16, the inner lining plate 12, the third side plate 15, the bottom plate 11, the second side plate 14, the fifth side plate 17, and the first side plate 13 are folded in turn along the first crease line 112, the second crease line 113, the third crease line 114, the fourth crease line 115, the fifth crease line 116, and the sixth crease line 117, to form the “L” shaped partition structure 1 shown in FIG. 1. In making full use of the foldability of the paperboard, the partition structure 1 has the advantages of simple operation and practicability. At the same time, the partition structure 1 meets the requirements of environmental protection.

In another embodiment, the fourth side plate 16, the inner lining plate 12, the third side plate 15, the bottom plate 11, the second side plate 14, the fifth side plate 17, and the first side plate 13 are made or can be made of plastic material, wood material, or metal material.

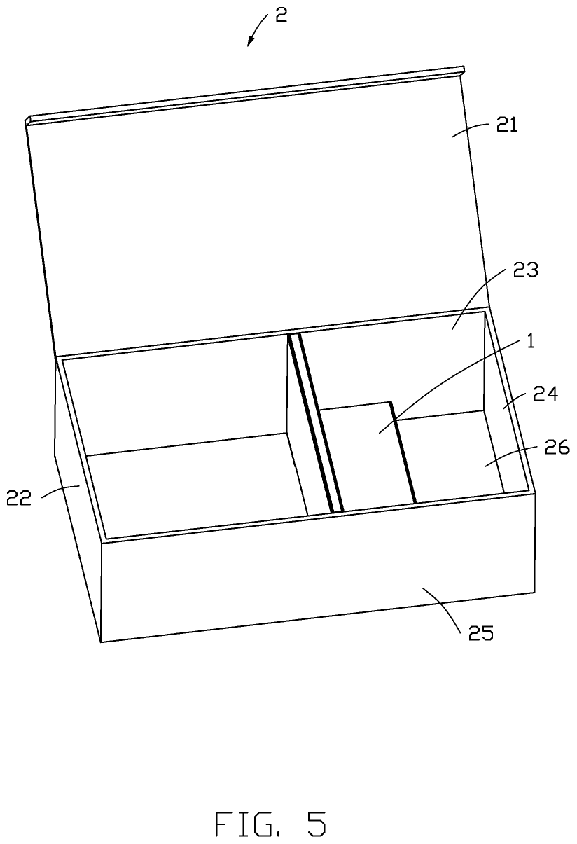

As shown in FIG. 5, the present disclosure further provides a packaging box 2. The packaging box 2 includes a cover plate 21, a first side wall 22, a second side wall 23, a third side wall 24, a fourth side wall 25, a fifth side wall 26, and the partition structure 1 of the above embodiments. The cover plate 21, the first side wall 22, the second side wall 23, the third side wall 24, the fourth side wall 25, and the fifth side wall 26 form a packaging box 2. One or more partition structures 1 are arranged in the packaging box 2, and the bottom plate 11 of the partition structure 1 is in contact with the third side wall 24. The length of the bottom plate 11 is slightly less than that of the first side wall 22. The height of the first side plate 13 and the second side plate 22 of the partition structure 1 is slightly less than the height of the packaging box 2.

In another embodiment, the lengths and widths of the relevant fourth side plate 16, the inner lining plate 12, third side plate 15, bottom plate 11, second side plate 14, fifth side plate 17, and first side plate 13 of the partition structure 1 can be adjusted according to the presented size of the packing box 2.

The partition structure 1 has an integral structure and is firmly fixed by the interleaved structure, the partition structure 1 saves paper and reduces consumption. At the same time, the size of the partition structure 1 can be adjusted to fit different packaging boxes 2, thus the partition structure 1 has the functions of separation, protection of contents, simple operation, and strong practicability.

The embodiments shown and described above are only examples. Therefore, many commonly-known features and details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size, and arrangement of the parts within the principles of the present disclosure, up to and including the full extent established by the broad general meaning of the terms used in the claims. It will, therefore, be appreciated that the embodiments described above may be modified within the scope of the claims.

What is claimed is:

1. A partition structure for packaging box comprising:
a bottom plate defining a first through hole;
an inner lining plate arranged at intervals with the bottom plate along a first direction, the inner lining plate defining a second through hole communicated with the first through hole along the first direction;
a first side plate arranged along the first direction, the first side plate comprising a tongue extending through the first through hole and the second through hole along the first direction; and
a second side plate connected with the bottom plate, wherein the second side plate and the first side plate are arranged at intervals along a second direction, and the second side plate is arranged on the same side of the bottom plate and the inner lining plate along the first direction, and
wherein the bottom plate, the inner lining plate, the first side plate and the second side plate are integrally connected.

2. The partition structure of claim 1, further comprising:
a third side plate arranged between the bottom plate and the inner lining plate;
wherein two opposite ends of the third side plate are respectively connected with the bottom plate and the inner lining plate.

3. The partition structure of claim 2, wherein the third side plate is arranged on a side of the bottom plate away from the first through hole, the third side plate is arranged on the side of the lining plate away from the second through hole, and the third side plate is arranged at intervals with the second side plate along the second direction.

4. The partition structure of claim 3, further comprising:
a fourth side plate connected with the lining plate;
wherein the third side plate and the fourth side plate are arranged on both sides of a back of the lining plate, and the fourth side plate extends towards the first through hole along the first direction and abuts the bottom plate.

5. The partition structure of claim 4, wherein a side of the fourth side plate away from the bottom plate is connected with a side of the inner lining plate adjacent to the second through hole, and the fourth side plate is arranged between the first side plate and the second side plate.

6. The partition structure of claim 5, further comprising:
a fifth side plate arranged between the first side plate and the second side plate;
wherein the fifth side plate is arranged at intervals with the bottom plate along the first direction, one side of the fifth side plate is connected with a side of the first side plate away from the tongue, and the other side of the fifth side plate is connected with a side of the second side plate away from the bottom plate.

7. The partition structure of claim 6, wherein the fourth side plate, the inner lining plate, the third side plate, the bottom plate, the second side plate, the fifth side plate and the first side plate are connected in sequence and arranged integrally.

8. The partition structure of claim 6, wherein an orthographic projection of the lining plate in the first direction covers an orthographic projection of the bottom plate, and an orthographic projection of the fifth side plate in the first direction projects over the first through hole and the second through hole; an orthographic projection of the second side plate in the second direction projects over an orthographic projection of the first side plate, and an orthographic projection of the third side plate in the second direction projects over an orthographic projection of the tongue and the fourth side plate.

9. The partition structure of claim 6, wherein a thickness of each of the fourth side plate, the inner lining plate, the third side plate, the bottom plate, the second side plate, the fifth side plate and the first side plate are greater than or equal to 1 mm.

10. A packaging box, comprising:
a cover plate, a first side wall, a second side wall, a third side wall, a fourth side wall, a fifth side wall; and
a partition structure comprising:
a bottom plate, defining a first through hole;
an inner lining plate, arranged at intervals with the bottom plate along the first direction, the inner lining plate defining a second through hole communicated with the first through hole along a first direction;
a first side plate, arranged along the first direction, the first side plate comprising a tongue, and the tongue passes through the first through hole and the second through hole along the first direction;
a second side plate connected with the bottom plate, wherein the second side plate and the first side plate are arranged at intervals along a second direction, and the second side plate is arranged on the same side of the bottom plate and the inner lining plate along the first direction; wherein the bottom plate, the inner lining plate, the first side plate and the second side plate are integrally connected;
wherein the cover plate, the first side wall, the second side wall, the third side wall, the fourth side wall and the fifth side wall surround to form the packaging box; one or more of the partition structures are arranged in the packaging box, and the bottom plate of the partition structure is in contact with the third side wall.

11. The packaging box of claim 10, wherein the partition structure further comprises a third side plate, the third side plate is arranged between the bottom plate and the inner lining plate, the two opposite ends of the third side plate are respectively connected with the bottom plate and the inner lining plate.

12. The packaging box of claim 11, wherein the third side plate is arranged on the side of the bottom plate away from the first through hole, the third side plate is arranged on the side of the lining plate away from the second through hole, and the third side plate is arranged at intervals with the second side plate along the second direction.

13. The packaging box of claim 12, wherein the partition structure further comprises a fourth side plate connected with the lining plate, the third side plate and the fourth side plate are arranged on both sides of the back of the lining plate, and the fourth side plate extends towards the first through hole along the first direction and butts with the bottom plate.

14. The packaging box of claim 13, wherein the side of the fourth side plate away from the bottom plate is connected with the side of the inner lining plate adjacent to the second through hole, and the fourth side plate is arranged between the first side plate and the second side plate.

15. The packaging box of claim 14, wherein the partition structure further comprises a fifth side plate arranged between the first side plate and the second side plate, the fifth side plate is arranged at intervals with the bottom plate along the first direction, one side of the fifth side plate is connected with the side of the first side plate away from the tongue, and the other side of the fifth side plate is connected with the side of the second side plate away from the bottom plate.

16. The packaging box of claim 15, wherein the fourth side plate, the inner lining plate, the third side plate, the bottom plate, the second side plate, the fifth side plate and the first side plate are connected in sequence and arranged integrally.

17. The packaging box of claim 15, wherein along the first direction, the orthographic projection of the lining plate covers the orthographic projection of the bottom plate, and the orthographic projection of the fifth side plate covers the first through hole and the second through hole; along the second direction, the orthographic projection of the second side plate covers the orthographic projection of the first side plate, and the orthographic projection of the third side plate covers the orthographic projection of the tongue and the fourth side plate.

18. The packaging box of claim 15, wherein the thickness of the fourth side plate, the inner lining plate, the third side plate, the bottom plate, the second side plate, the fifth side plate and the first side plate are greater than or equal to 1 mm.
